(19) United States
(12) Patent Application Publication
(10) Pub. No.: US 2021/0096625 A1
(43) Pub. Date: Apr. 1, 2021

(54) Information Processing Apparatus And Information Processing System

(71) Applicant: FUJITSU CLIENT COMPUTING LIMITED, KAWASAKI-SHI (JP)

(72) Inventors: Tatsuya SHIMURA, Kanagawa (JP); Akira TAKEUCHI, Kanagawa (JP)

(21) Appl. No.: 16/930,468

(22) Filed: Jul. 16, 2020

(30) Foreign Application Priority Data
Sep. 26, 2019 (JP) 2019-175038

(51) Int. Cl. G06F 1/26; G06F 1/28; G06F 1/3215

(52) U.S. Cl. CPC G06F 1/266; G06F 1/3215; G06F 1/28

(57) ABSTRACT

An information processing apparatus includes a control unit and a peripheral device, which includes a relay device, a computational processing device group, and a power supply unit. The peripheral device is connected to a host apparatus. The relay device relays communication via an expansion bus. The computational processing device group includes a plurality of computational processing devices individually connected to the expansion bus. The power supply unit is a power supply for the operation power. The control unit executes control over supplying of the operation power to the host apparatus and the peripheral device, monitors an operation state of a power switch, and is operable when a long press of a predetermined time or longer of the power switch has been detected, to shut off the operation power being supplied to the host apparatus and the peripheral device in a predetermined order.

### CROSS-REFERENCE TO RELATED APPLICATION

This application is based upon and claims the benefit of priority of the prior Japanese Patent Application No. 2019-175038, filed on Sep. 26, 2019, the entire contents of which are incorporated herein by reference.

### FIELD

The embodiments discussed herein are related to an information processing apparatus and an information processing system.

### BACKGROUND

An information processing system where communication between a host PC (Personal Computer) and a coprocessor is performed using an expansion bus such as PCIe (Peripheral Component Interconnect Express, registered trademark) has been developed.

On the other hand, with a normal PC, it is possible to forcibly shut off the operation power of the PC, such as by the user performing a long press of a predetermined time or longer of a power switch provided on the PC.

See, for example, Japanese Laid-open Patent Publication No. 2019-109625.

An information processing system like that described above where a plurality of coprocessors are connected to a host PC via PCIe is not provided with a sequence for collectively shutting off the operation power of the devices constructing the system.

Although it is possible to forcibly shut off the operation power of a host PC by performing a long press of a predetermined time or longer of the power switch in the same way as a normal PC, this will not shut off the operation power of a PCIe controller, the coprocessors, and the like. This means it is needed to shut off the operation power individually on a device-by-device basis, which reduces the operability and user-friendliness of the system.

### SUMMARY

According to an aspect, there is provided an information processing apparatus including: a peripheral device connected to a host apparatus; and a control unit that executes control over supplying of operation power to the host apparatus and the peripheral device, monitors an operation state of a power switch, and is operable when a long press of a predetermined time or longer of the power switch has been detected, to shut off the operation power being supplied to the host apparatus and the peripheral device in a predetermined order.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 depicts one example of an information processing system;

FIG. 2 depicts an example configuration of the information processing system;

FIG. 3 depicts an example application of the information processing system to edge computing;

FIG. 4 depicts an example hardware configuration of a power control unit;

FIG. 5 is a flowchart depicting one example of power control;

FIG. 6 is a flowchart depicting one example of power control;

FIG. 7 is a flowchart depicting one example of power control;

FIG. 8 is a flowchart depicting the operation of a first example modification to power control; and

FIG. 9 is a flowchart depicting the operation of a second example modification to power control.

### DESCRIPTION OF EMBODIMENTS

Several embodiments will be described below with reference to the accompanying drawings.

### First Embodiment

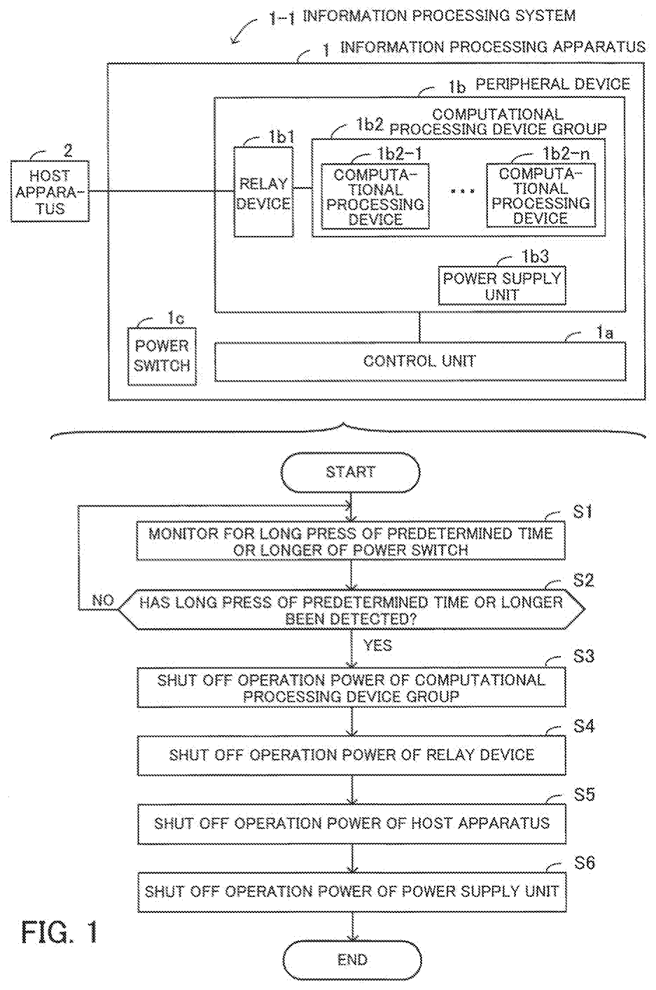

FIG. 1 depicts one example of an information processing system. The information processing system 1-1 includes an information processing apparatus 1 and a host apparatus 2. The information processing apparatus 1 includes a control unit 1a, a peripheral device 1b, and a power switch 1c. The peripheral device 1b is connected to the host apparatus 2.

The peripheral device 1b is equipped with a relay device 1b1, a computational processing device group 1b2, and a power supply unit 1b3. The relay device 1b1 includes an expansion bus (for example, PCIe) and relays communication between the host apparatus 2 and the computational processing device group 1b2 via the expansion bus.

The computational processing device group 1b2 includes a plurality of computational processing devices 1b2-1, . . . , 1b2-n that are individually connected to the expansion bus. The computational processing devices 1b2-1, . . . , 1b2-n execute computational processing, such as AI (Artificial Intelligence) logic processing and image processing, based on instructions from the host apparatus 2. The power supply unit 1b3 supplies power and serves as the power supply for the operation power.

The control unit 1a controls the supplying of the operation power to the host apparatus 2 and the peripheral device 1b. The control unit 1a also monitors an operation state of the power switch 1c, and when a long press of a predetermined time or longer of the power switch 1c has been detected, shuts off the operation power being supplied to the host apparatus 2 and the peripheral device 1b in a predetermined order.

The operation flow of the control unit 1a will now be described.

[Step S1] The control unit 1a monitors whether there has been a long press of a predetermined time or longer of the power switch 1c.

[Step S2] When a long press of the predetermined time or longer of the power switch 1c has been detected, the control unit 1a advances the processing to step S3, while when a long press of the predetermined time or longer of the power switch 1c has not been detected, the processing returns to step S1.

[Step S3] The control unit 1a shuts off the operation power being supplied to the computational processing device group 1b2.

[Step S4] The control unit 1a shuts off the operation power being supplied to the relay device 1b1.

[Step S5] The control unit 1a shuts off the operation power being supplied to the host apparatus 2.

[Step S6] The control unit 1a shuts off the operation power being supplied by the power supply unit 1b3 (i.e., stops the outputting of the operation power).

In this way, in the information processing apparatus 1, the operation state of the power switch 1c is monitored, and when a long press of a predetermined time or longer of the power switch 1c has been detected, the operation power being supplied to the host apparatus 2 and the peripheral device 1b is shut off.

By providing a power shut-off sequence like that described above, it is possible to collectively shut off the operation power of every device constructing the system and thereby possible to improve the operability and user-friendliness of the system. Since the operation power is shut off in the order given in step S3 to step S6, it is possible to shut off the operation power in a stable manner.

### Second Embodiment

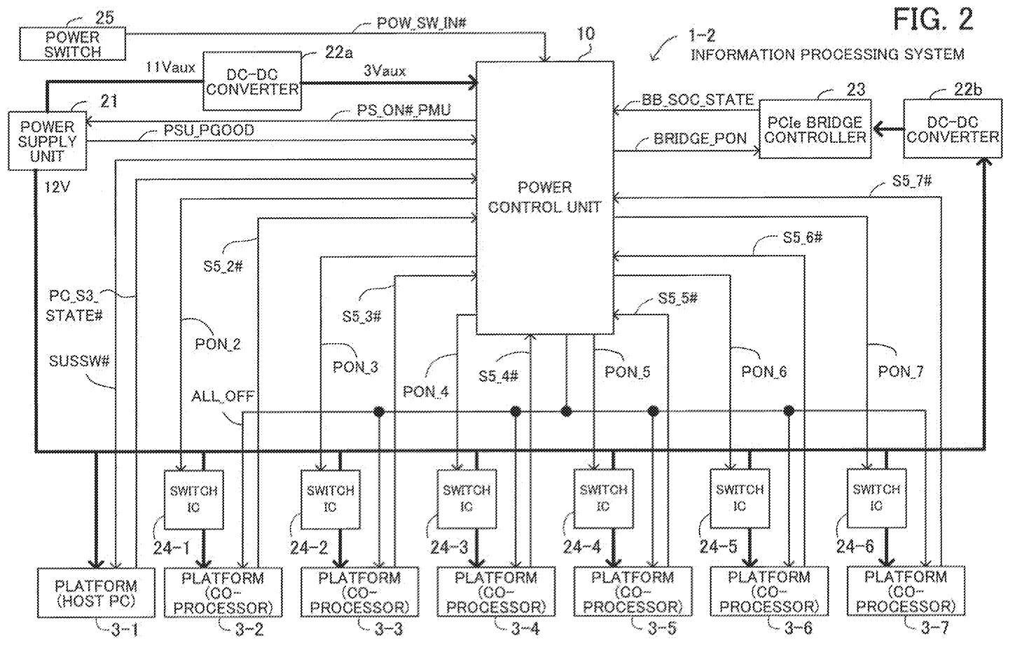

An information processing system that uses PCIe as one example of an expansion bus will now be described as a second embodiment. FIG. 2 depicts an example configuration of an information processing system. An information processing apparatus 1-2 is equipped with a power control unit 10, a power supply unit (PSU) 21, DC (Direct Current)—DC converters 22a and 22b, a PCIe bridge controller 23, switch ICs (integrated circuits) 24-1, . . . , 24-6, a power switch 25, and platforms 3-1, . . . , 3-7.

The PSU 21 has the functions of the power supply unit 1b3 depicted in FIG. 1. The PSU 21 converts an AC (Alternating Current) voltage supplied from a commercial power supply to a DC voltage of a predetermined voltage value and supplies the DC voltage to the platforms 3-1, . . . , 3-7, the switch ICs 24-1, . . . , 24-6, and the DC-DC converters 22a and 22b.

Note that the PSU 21 generates operation power and standby power as DC voltages. As examples, the voltage value of the operation power is 12 V and the voltage value of the standby power is 11 V. The operation power is power supplied when the individual devices constructing the system are operating and the standby power is the power consumed in a state where devices are plugged into an outlet but the power is off.

The DC-DC converter 22a converts the standby power supplied from the PSU 21 to a power supply voltage (for example, 3 V) of the power control unit 10 which is supplied to the power control unit 10. The PCIe bridge controller 23 has the functions of the relay device 1b1 depicted in FIG. 1 and controls relayed communication between the platforms 3-1, . . . , 3-7.

The power control unit 10 runs based on the standby power and has the functions of the control unit la depicted in FIG. 1. The power control unit 10 receives operations of the power switch 25 and performs power control over the platform 3-1, the PSU 21, and the PCIe bridge controller 23. In addition, the power control unit 10 performs power control over the platforms 3-2, . . . , 3-7 via the switch ICs 24-1, . . . , 24-6.

The switch ICs 24-1, . . . , 24-6 are placed under the control of the power control unit 10 and supply or shut off power to the platforms 3-2, . . . , 3-7 to which they are connected based on switch control instructions from the power control unit 10.

The DC-DC converter 22b converts the operation power supplied from the PSU 21 to the power supply voltage of the PCIe bridge controller 23 and supplies to the PCIe bridge controller 23.

The platform 3-1 is provided with an operating system (OS), such as Windows (registered trademark), and collectively manages the other platforms 3-2, . . . , 3-7. That is, the platform 3-1 functions as a host PC (the host apparatus 2).

The platforms 3-2, . . . , 3-7 are equipped with OSs such as Linux (registered trademark), and perform standalone or cooperative processing under control of the platform 3-1. That is, the platforms 3-2, . . . , 3-7 function as coprocessors (computational processing devices).

Various GPIO (General Purpose Input Output) signals of the power control unit 10 will now be described. A signal POW_SW_IN# is a signal (or “first shut-off signal”) outputted from the power switch 25 to the power control unit 10 when the power switch 25 has been pressed. The power control unit 10 monitors the time for which this signal is outputted to determine whether a long press has been performed.

A signal PS_ON#_PMU is outputted from the power control unit 10 to the PSU 21 and is a signal for setting whether operation power is to be outputted from the PSU 21 or stopped.

As one example, when the signal PS_ON#_PMU is at the L level, the operation power is outputted from the PSU 21, while when the signal PS_ON#_PMU is at the H level, the outputting of the operation power from the PSU 21 is stopped.

A signal PSU_PGOOD is outputted from the PSU 21 to the power control unit 10 and is a signal for notifying the power control unit 10 of a startup state of the PSU 21. As one example, when the signal PSU_PGOOD is at the H level, the PSU 21 has started up (a state where the operation power is being outputted), while when the signal PSU_PGOOD is at the L level, the PSU 21 has not started up (a state where the outputting of operation power is stopped).

Signals PON_n (where n=2, . . . , 7) are outputted from the power control unit 10 to the switch ICs 24-1, . . . , 24-6 and are signals that individually switch the switch ICs 24-1, . . . , 24-6 to perform on/off control of the power of the platforms 3-2, . . . , 3-7.

As one example, when the signals PON_n are at the L level, the switch ICs 24-1, . . . , 24-6 are turned off. By cutting off the lines on which operation power flows within the switch ICs, the operation power of the platforms 3-2, . . . , 3-7 is shut off.

When the signals PON_n are at the H level, the switch ICs 24-1, . . . , 24-6 are turned on. By connecting the lines on which operation power flows within the switch ICs, the operation power is supplied to the platforms 3-2, . . . , 3-7.

A signal ALL_OFF is outputted from the power control unit 10 to the platforms 3-2, . . . , 3-7 and is a signal for instructing the OSs of the platforms 3-2, . . . , 3-7 to perform a system shutdown. As one example, when the signal ALL_OFF is at the H level, the platforms 3-2, . . . , 3-7 start to shut down.

Signals S5_n# (where n=2, . . . , 7) are outputted from the platforms 3-2, . . . , 3-7 to the power control unit 10 and are signals for notifying the power control unit 10 of the computational processing states of the platforms 3-2, . . . , 3-7.

As one example, when the signals S5_n# are at the H level, the platforms 3-2, . . . , 3-7 are in an execution state for computational processing, while when the signals S5_n# are at the L level, this means that the platforms 3-2, . . . , 3-7 are in a non-execution state for computational processing (which includes the shutdown state).

A signal BRIDGE_PON is outputted from the power control unit 10 to the PCIe bridge controller 23 and is a signal for supplying or shutting off the operation power of the PCIe bridge controller 23.

As one example, when the signal BRIDGE_PON is at the H level, the operation power is supplied to the PCIe bridge controller 23, while when the signal BRIDGE_PON is at the L level, the operation power of the PCIe bridge controller 23 is shut off.

The signal BB_SOC_STATE is outputted from the PCIe bridge controller 23 to the power control unit 10 and is a signal that notifies the power control unit 10 of a startup state of the PCIe bridge controller 23.

As one example, when the signal BB_SOC_STATE is at the H level, the PCIe bridge controller 23 has started up, while when the signal BB_SOC_STATE is at the L level, the PCIe bridge controller 23 has not started up.

A signal SUSSW# is a power switch signal that is outputted from the power control unit 10 to the platform 3-1. The expression “power switch signal” refers to a signal that serves as (a power supplying instruction and) a system startup instruction when the platform 3-1 has not started up and as a system shutdown instruction (and a power shut-off instruction) when the platform 3-1 has started up. As one example, when the signal SUSSW# is at the H level, the power switch signal has not been inputted into the platform 3-1, while when the signal SUSSW# is at the L level, the power switch signal has been inputted into the platform 3-1. When the signal SUSSW# is at the L level continuously for a set time in a state where the platform 3-1 has started up, this becomes a forcible power shut-off instruction with a system shutdown instruction being omitted.

A signal PC_S3_STATE# is outputted from the platform 3-1 to the power control unit 10 and is a signal that notifies the power control unit 10 of the startup state of the platform 3-1. As one example, when the signal PC_S3_STATE# is at the L level, the platform 3-1 has started up, while when the signal PC_S3_STATE# is at the H level, the platform 3-1 has not started up.

### Application to Edge Computing

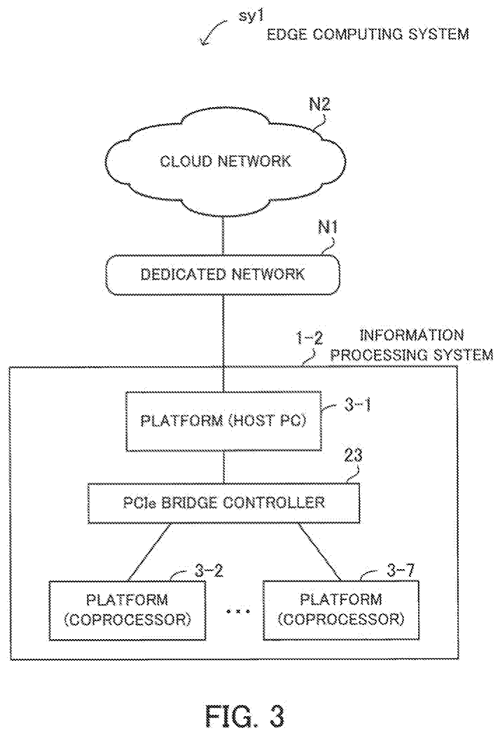

FIG. 3 depicts an example application of the information processing system to edge computing. It is possible to regard the platform 3-1 (host PC) described above in FIG. 2 as an edge server and apply the information processing system 1-2 to edge computing.

An edge computing system sy1 includes the information processing system 1-2, a dedicated network N1 (such as the Internet), and a cloud network N2. The platform 3-1 in the information processing system 1-2 is connected to the dedicated network N1 and the dedicated network N1 is connected to the cloud network N2.

The platform 3-1 collects data that has been subjected to distributed processing by the platforms 3-2, . . . , 3-7 via the PCIe bridge controller 23, and transmits the data via the dedicated network N1 to the cloud network N2.

With this configuration, it is possible to save resources on the cloud and perform processing at the edge. By doing so, since the response time taken by processing via the cloud network N2 is reduced, real-time response is ensured.

Since data is processed at the platform 3-1 (the edge) and the result is transmitted to the cloud network N2, it is possible to protect the confidentiality of the data. In addition, since data is processed at the platform 3-1 and only the required data is transmitted to the cloud network N2, it is possible to reduce the amount of communication.

### Hardware Configuration

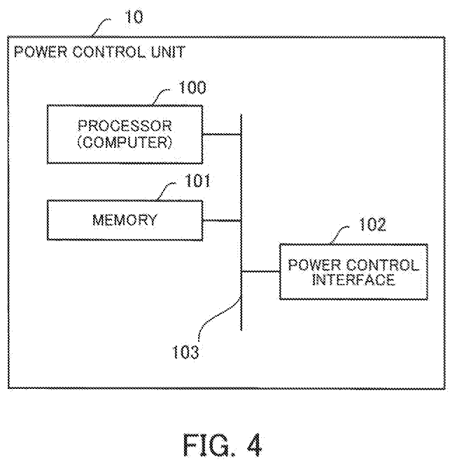

FIG. 4 depicts an example hardware configuration of a power control unit. The power control unit 10 is subject to overall control by a processor (computer) 100.

The processor 100 is connected via a bus 103 to a memory 101 and a power control interface 102. The processor 100 may be a multiprocessor. As examples, the processor 100 is a CPU (Central Processing Unit), an MPU (Micro Processing Unit), a DSP (Digital Signal Processor), an ASIC (Application Specific Integrated Circuit), or a PLD (Programmable Logic Device). The processor 100 may also be a combination of two or more of a CPU, an MPU, a DSP, an ASIC, and a PLD.

The memory 101 includes ROM (Read Only Memory), RAM (Random Access Memory), and the like, and is used as a main storage device of the power control unit 10. At least part of a program and/or an application program to be executed by the processor 100 is temporarily stored in the memory 101.

The memory 101 also stores various data used in processing by the processor 100. The memory 101 is also used as an auxiliary storage device of the power control unit 10 and stores programs, application programs, and various data.

The power control interface 102 serves as an input/output interface for GPIO based on instructions by the processor 100. In more detail, the power control interface 102 performs interface control for connecting to the PCIe bridge controller 23, the switch ICs 24-1, . . . , 24-6, and the platforms 3-1, . . . , 3-7 on GPIO signal lines and supplying or shutting off power. Note that the interface function of the power control interface 102 may be realized by the processor 100.

By using the hardware configuration described above, it is possible to realize the processing functions of the power control unit 10. As one example, by having the processor 100 execute predetermined programs, the power control unit 10 is capable of executing power control according to the present embodiments.

As one example, by executing programs recorded on a computer-readable recording medium, the power control unit 10 is capable of realizing the processing functions according to the present embodiments. It is possible to record a program in which the processing content to be executed by the power control unit 10 is written on a variety of recording media.

As one example, it is possible to store a program to be executed by the power control unit 10 in an auxiliary storage device. The processor 100 loads at least part of the program in the auxiliary storage device into the main storage device and executes the program.

It is also possible to record the program on a portable recording medium such as an optical disc, a memory device, a memory card, or the like. As one example, a program stored on a portable recording medium is installed into the auxiliary storage device under control by the processor 100 so as to become executable. The processor 100 may also be capable of reading out and executing the program directly from a portable recording medium.

### Power Control Flow

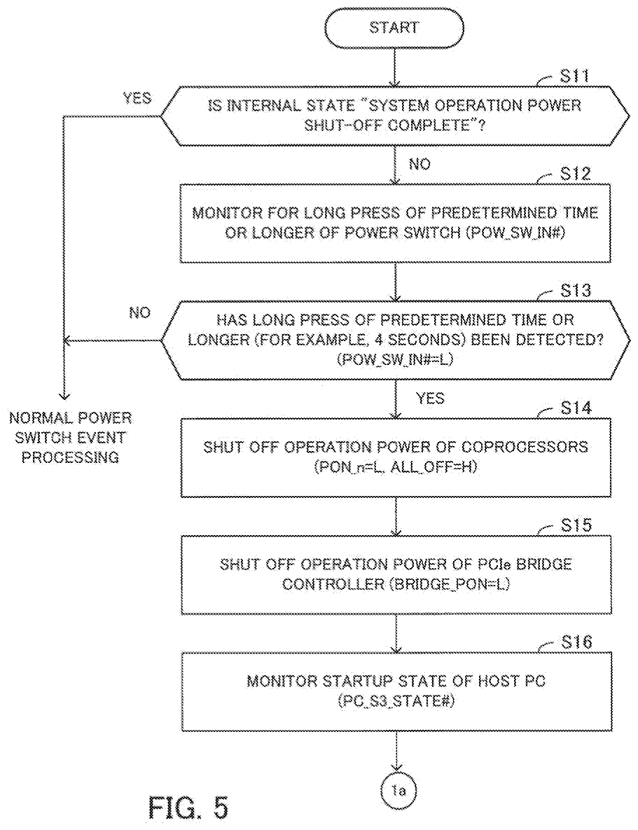

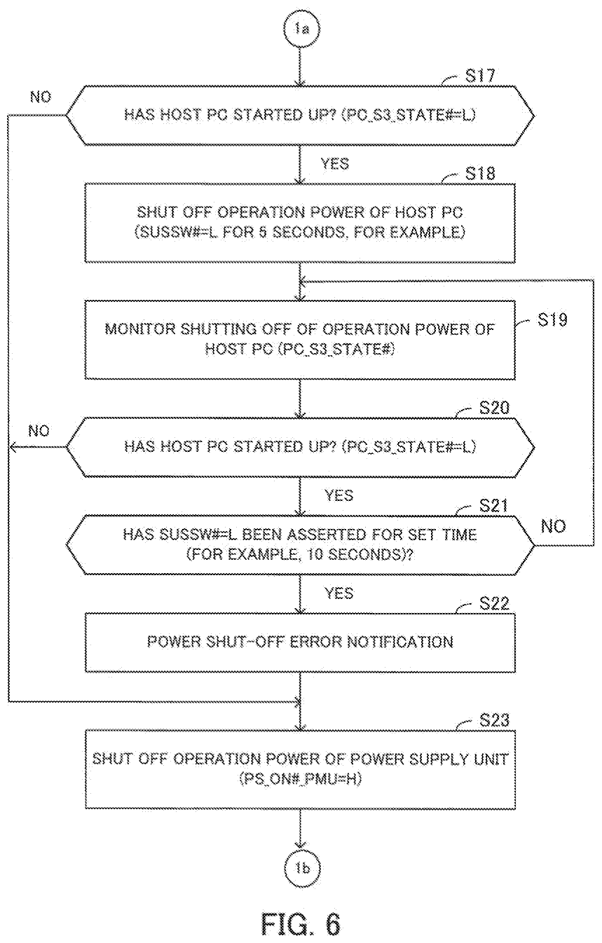

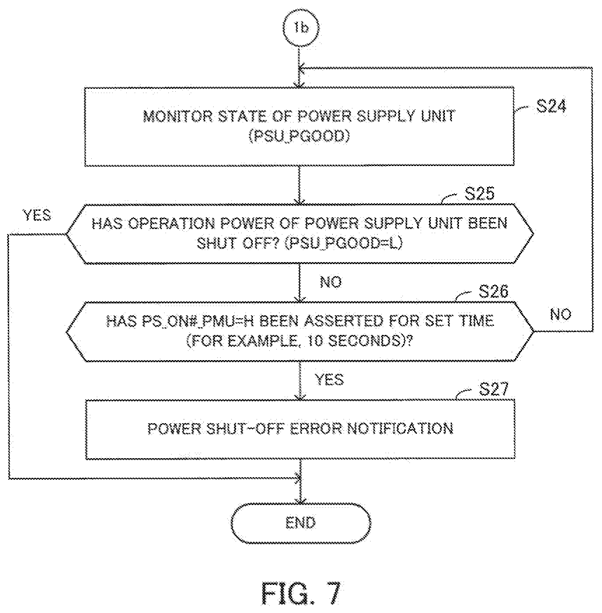

FIGS. 5 to 7 are flowcharts depicting one example of power control.

[Step S11] The power control unit 10 determines whether the internal state is “system operation power shut-off complete”. When the internal state is “system operation power shut-off complete”, normal power switch event processing is performed, while when the internal state is not “system operation power shut-off complete”, the processing proceeds to step S12.

[Step S12] The power control unit 10 monitors whether the power switch 25 has been subjected to a long press of a predetermined time or longer (as one example, four seconds or longer) based on the signal POW_SW_IN# outputted from the power switch 25.

[Step S13] The power control unit 10 determines whether there has been a long press of the power switch 25 based on the signal POW_SW_IN# outputted from the power switch 25.

As one example, when it has been detected that the signal POW_SW_IN# has been at the L level for the predetermined time or longer, it is recognized that the power switch 25 has been subjected to a long press of the predetermined time or longer and the processing proceeds to step S14. Conversely, when the signal POW_SW_IN# is not at the L level for the predetermined time or longer, normal power switch event processing is performed.

[Step S14] The power control unit 10 shuts off operation power to the platforms 3-2, . . . , 3-7 (coprocessors). Here, the power control unit 10 sets the signals PON_2, . . . , PON_7 at the L level to turn off the switch ICs 24-1, . . . , 24-6 and then shuts off the operation power of the platforms (coprocessors) 3-2, . . . , 3-7. After this, the signal ALL_OFF is set at the H level in readiness for the next startup.

[Step S15] The power control unit 10 shuts off the operation power of the PCIe bridge controller 23. At this time, the power control unit 10 sets the signal BRIDGE_PON at the L level to shut off the operation power of the PCIe bridge controller 23.

[Step S16] The power control unit 10 monitors the startup state of the platform 3-1 (host PC) based on the level of the signal PC_S3_STATE# outputted from the platform 3-1 (host PC).

[Step S17] The power control unit 10 determines whether the signal PC_S3_STATE# outputted from the platform 3-1 (host PC) is at the L level.

When it has been detected that the signal PC_S3_STATE# is at the L level, it is recognized that the platform 3-1 (host PC) has started up, and the processing proceeds to step S18. When the signal PC_S3_STATE# is at the H level, it is recognized that the platform 3-1 (host PC) has not started up and the processing proceeds to step S23.

[Step S18] The power control unit 10 shuts off the operation power of the platform 3-1 (host PC). Here, the power control unit 10 generates the signal SUSSW# that is a pseudo signal for the signal POW_SW_IN# and has an L level for a first set time (for example, 5 seconds) that is longer than the L level of the predetermined time of the signal POW_SW_IN#.

As one example, when a long press of a predetermined time or longer has been made of the power switch 25, at the point where the signal POW_SW_IN# has been at the L level for 4 seconds, the signal SUSSW#, which is a pseudo version of the signal POW_SW_IN#, is generated by extending the time for which the L level is set so that the L level is held for five seconds. This signal SUSSW# is then outputted to the platform 3-1 to forcibly shut off the power supply to the platform 3-1.

[Step S19] The power control unit 10 monitors the startup state of the platform 3-1 (host PC) based on the level of the signal PC_S3_STATE# outputted from the platform 3-1 (host PC).

[Step S20] The power control unit 10 determines whether the platform 3-1 (host PC) has started up based on the signal PC_S3_STATE# outputted from the platform 3-1 (host PC).

When it has been detected that the signal PC_S3_STATE# is at the L level, it is recognized that the platform 3-1 (host PC) has started up and the processing proceeds to step S21. When the signal PC_S3_STATE# is at the H level, it is recognized that the platform 3-1 (host PC) has not started up and the processing proceeds to step S23.

[Step S21] The power control unit 10 determines whether assertion of the L level of the signal SUSSW# has continued for the second set time (for example, 10 seconds) that is longer than the first set time set in Step S18.

When the assertion of the L level of signal SUSSW# is shorter than the second set time, the processing returns to step S19, and when assertion of the L level of the signal SUSSW# has reached the second set time, the processing proceeds to step S22.

[Step S22] The power control unit 10 recognizes that it is not possible to shut off the operation power of the platform 3-1 (host PC). Here, the power control unit 10 gives notification of a power shut-off error by issuing an alarm, using LEDs (Light Emitting Diodes) or the like, based on the standby power. Note that since the standby power is used to give notification of a power shut-off error, the power control unit 10 is able to perform error notification processing regardless of whether the operation power has been shut off.

[Step S23] The power control unit 10 shuts off the operation power of the PSU 21. Here, the power control unit 10 sets the signal PS_ON#_PMU at the H level to shut off the operation power of the PSU 21.

[Step S24] The power control unit 10 monitors the start-up state of the PSU 21 based on the level of the signal PSU_PGOOD outputted from the PSU 21.

[Step S25] The power control unit 10 determines whether the PSU 21 has been shut off based on the signal PSU_PGOOD outputted from the PSU 21.

When it is detected that the signal PSU_PGOOD is at the H level, it is recognized that the operation power of the PSU 21 has not been shut off, and the processing proceeds to step S26. When the signal PSU_PGOOD is at the L level, it is recognized that the operation power of the PSU 21 has been shut off and the processing ends.

[Step S26] The power control unit 10 determines whether assertion of the H level of the signal PS_ON#_PMU has continued for a set time (for example, 10 seconds).

When assertion of the H level of the signal PS_ON#_PMU is shorter than the set time, the processing returns to step S24, and when the assertion of the H level of the signal PS_ON#_PMU has reached the set time, the processing proceeds to step S27.

[Step S27] The power control unit 10 recognizes that it is not possible to shut off the operation power of the PSU 21. At this time, the power control unit 10 gives notification of a power shut-off error by emitting an alarm using LEDs or the like based on the standby power.

Note that when it has been possible to normally shut off the operation power of the platforms 3-2, . . . , 3-7 (coprocessors), the PCIe bridge controller 23, the platform 3-1 (host PC), and the PSU 21 in that order, the power control unit 10 sets the internal state at “system operation power shut-off complete”.

By configuring the information processing system 1-2 as described above, when a long press of a predetermined time or longer is made of the power switch 25, it is possible to collectively shut off the operation power of the entire system by launching a shut-off sequence for the operation power of each device constructing the system.

Since the operation power is shut off for the platforms 3-2, . . . , 3-7 (coprocessors), the PCIe bridge controller 23, the platform 3-1 (host PC), and the PSU 21 in that order, it is possible to stably shut off the operation power.

In addition, since shutting off of the operation power of the devices constructing the system is also performed when a long press of the predetermined time or longer of the power switch 25 is performed in a state where the internal state is not “system operation power shut-off complete”, it is possible to safely shut off the operation while avoiding malfunctions.

The system is also configured so that during shut-off control of the operation power of the platform 3-1 (host PC), the signal POW_SW_IN# (or “first power shut-off instruction”) outputted when a long press of the predetermined time or longer of the power switch 25 is performed is inputted into the power control unit 10 without being inputted into the platform 3-1 (host PC).

When the signal POW_SW_IN# has been detected, the power control unit 10 generates the signal SUSSW# (or “second power shut-off instruction”) that has the L level for a longer time than the signal POW_SW_IN# and outputs to the platform 3-1. The operation power of the platform 3-1 (host PC) is then shut off using this signal SUSSW# that is a pseudo signal for the signal POW_SW_IN#. By doing so, it is possible to safely and precisely shut off the platform 3-1 (host PC).

### Modifications to Power Control

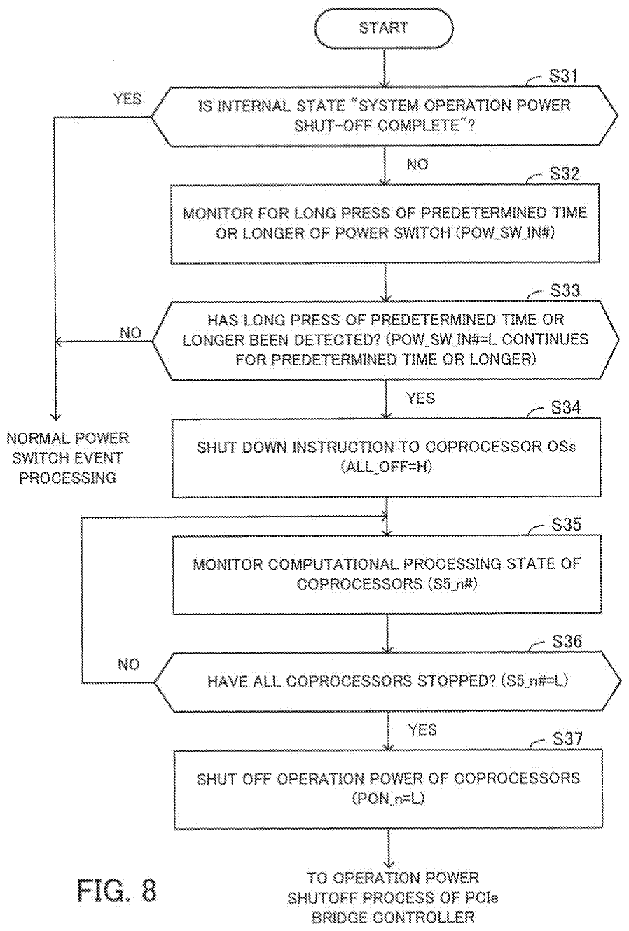

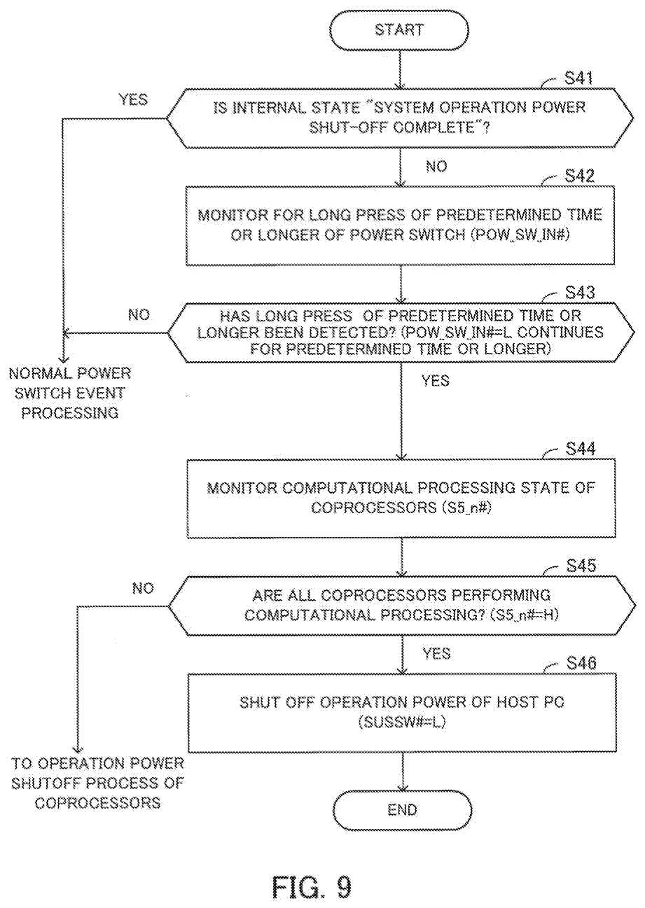

Next, example modifications to the power control will be described with reference to FIGS. 8 and 9. FIG. 8 is a flowchart depicting the operation of a first example modification to the power control. In this first modification, the operation power of the coprocessors is shut off when it has been recognized that computational processing by all of the coprocessors has stopped.

[Step S31] The power control unit 10 determines whether the internal state is “system operation power shut-off complete”. When the internal state is “system operation power shut-off complete”, normal power switch event processing is performed, while when the internal state is not “system operation power shut-off complete”, the processing proceeds to step S32.

[Step S32] The power control unit 10 monitors whether a long press of a predetermined time or longer (for example, 4 seconds or longer) has been made of the power switch 25 based on the level of the signal POW_SW_IN# outputted from the power switch 25.

[Step S33] Based on the signal POW_SW_IN# outputted from the power switch 25, the power control unit 10 determines whether a long press of the power switch 25 has been made.

When it has been detected that the signal POW_SW_IN# is at the L level for a predetermined time or longer, it is recognized that a long press of the predetermined time or longer has been made of the power switch 25, and the processing proceeds to step S34. When the signal POW_SW_IN# is not at the L level for the predetermined time or longer, normal power switch event processing is performed.

[Step S34] The power control unit 10 instructs the OSs of the platforms 3-2, . . . , 3-7 (coprocessors) to perform a system shutdown. In this case, the power control unit 10 sets the signal ALL_OFF at the H level to give a system shutdown instruction to the respective OSs of the platforms 3-2, . . . , 3-7 (coprocessors).

[Step S35] The power control unit 10 monitors the signals S5_2#, . . . , S5_7# which indicate the computational processing states of the platforms 3-2, . . . , 3-7 (coprocessors).

[Step S36] The power control unit 10 determines whether all of the signals S5_2#, . . . , S5_7# have become the L level. When the OSs of the platforms 3-2, . . . , 3-7 (coprocessors) have all completed a shutdown and all of the signals S5_2#, . . . , S5_7# have been set at the L level, (that is, a “computational processing non-execution state”), the processing proceeds to step S37. When not all of the signals S5_2#, . . . , S5_7# have become the L level (that is, when there is still a coprocessor in the computational processing execution state), the processing returns to step S35.

[Step S37] The power control unit 10 sets the signals PON_2, . . . , PON_7 at the L level to shut off the operation power of the platforms (coprocessors) 3-2, . . . , 3-7. After this, the processing switches to the operation power shut-off process (step S15) for the PCIe bridge controller 23 depicted in FIG. 5.

In the flow in FIG. 5, PON_n is immediately set at the L level when the operation power of the platforms (coprocessors) 3-2, . . . , 3-7 is shut off, but when this happens, there is the risk of a kernel crash occurring at the platforms (coprocessors) 3-2, . . . , 3-7.

To avoid this, when shutting off the operation power of the platforms (coprocessors) 3-2, . . . , 3-7, the power control unit 10 in the first example modification described above first sets the signal ALL_OFF at H to give a shutdown instruction to the OSs of the platforms (coprocessors) 3-2, . . . , 3-7.

After this, the power control unit 10 monitors the signals S5_n#, which indicate the computational processing states of the platforms (coprocessors) 3-2, . . . , 3-7, and on confirming that the signal S5_n# is at the L level for every coprocessor, sets the signal PON_n at the L level to shut off the operation power. By doing so, it is possible to shut off the operation power of the platforms (coprocessors) 3-2, . . . , 3-7 while preventing a kernel crash at the coprocessors.

FIG. 9 is a flowchart depicting the operation of a second modification to the power control. This second modification is a case where the operation power of only the host PC is shut off.

[Step S41] The power control unit 10 determines whether the internal state is “system operation power shut-off complete”. When the internal state is “system operation power shut-off complete”, normal power switch event processing is performed. When the internal state is not “system operation power shut-off complete”, the processing proceeds to step S42.

[Step S42] The power control unit 10 monitors whether there has been a long press of a predetermined time or longer (for example, 4 seconds or longer) of the power switch 25 based on the level of the signal POW_SW_IN# outputted from the power switch 25.

[Step S43] The power control unit 10 determines whether a long press of the power switch 25 has been made based on the signal POW_SW_IN# outputted from the power switch 25.

When it has been detected that the signal POW_SW_IN# is at L level for a predetermined time or longer, it is recognized that a long press of a predetermined time or longer of the power switch 25 has been made, and the processing proceeds to step S44. When the signal POW_SW_IN# is not at the L level for the predetermined time or longer, normal power switch event processing is performed.

[Step S44] The power control unit 10 monitors the signals S5_2#, . . . , S5_7#, which indicate the computational processing states of the platforms 3-2, . . . , 3-7 (coprocessors).

[Step S45] The power control unit 10 determines whether all of the signals S5_2#, . . . , S5_7# are at the H level. When all of the signals S5_2#, . . . , S5_7# are at the H level (the “computational processing execution state”), the processing proceeds to step S46. When all of the signals S5_2#, . . . , S5_7# are at the L level (the computational processing non-execution state), the processing switches to the operation power shut-off process (step S37) for the platforms 3-2, . . . , 3-7 (coprocessors) depicted in FIG. 8.

[Step S46] The power control unit 10 shuts off the operation power of the platform 3-1 (host PC). As one example, the power control unit 10 asserts SUSSW#=L for a predetermined time.

Here, there is also a conceivable case where it is desirable to forcibly shut down only the platform 3-1 (host PC), due to the platform 3-1 hanging up but the coprocessors operating normally, thereby making it desirable for the operations of the coprocessors to continue.

This second modification also copes with this conceivable case. To do so, the power control unit 10 skips the operation power shut-off process of the platforms 3-2, . . . , 3-7 (coprocessors), the PCIe bridge controller 23, and the PSU 21 when the signals S5_n# are all at the H level (in the execution of computational processing) and shuts off the operation power of only the platform 3-1 (host PC) (and automatically restarts the platform 3-1 after a certain time). By doing so, it is possible to shut off the operation power of only the host PC that has hung up.

The processing functions of the information processing systems 1-1 and 1-2 of the present embodiments described above are realized by a computer. When doing so, a program in which the processing content of the functions to be provided in the information processing systems 1-1 and 1-2 are written is provided. By having a computer execute this program, the processing functions described above are realized by the computer.

The program in which the processing content is written may be recorded in advance on a computer-readable recording medium. Computer-readable recording media include magnetic storage devices, optical discs, magneto-optical recording media, and semiconductor memories. Magnetic storage devices include hard disk devices (HDD), flexible disks (FD), and magnetic tapes. Optical discs include CD-ROM (Compact Disc Read Only Memory)/RW and the like. Magneto-optical recording media include MO (Magneto Optical) discs.

To distribute the program, as one example, a portable recording medium, such as a CD-ROM, on which the program is recorded is sold. It is also possible to store the program in a storage device of a server computer and to transfer the program from the server computer via a network to another computer.

As examples, the computer that executes the program may store the program recorded on a portable recording medium or the program transferred from the server computer in its own storage device. The computer may then read out the program from its own storage device and execute processing according to the program. Note that it is also possible for the computer to read the program directly from the portable recording medium and execute processing according to the program.

It is also possible for a computer to sequentially execute processing according to a received program each time the program is transferred from a server computer connected via the network. Also, at least some of the processing functions described above may be realized by electronic circuits, such as a DSP, an ASIC, or a PLD.

According to the present embodiments, it is possible to collectively shut off operation power.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. An information processing apparatus comprising:
a peripheral device connected to a host apparatus; and
a control unit that executes control over supplying of operation power to the host apparatus and the peripheral device, monitors an operation state of a power switch, and is operable when a long press of a predetermined time or longer of the power switch has been detected, to shut off the operation power being supplied to the host apparatus and the peripheral device in a predetermined order.

2. The information processing apparatus according to claim 1,
wherein the peripheral device includes:
a relay device that has an expansion bus and relays communication via the expansion bus;
a computational processing device group including a plurality of computational processing devices that are individually connected to the expansion bus; and
a power supply unit that is a power supply for the operation power, and
the control unit shuts off the operation power to the computational processing device group, the relay device, and the host apparatus before shutting off the operation power of the power supply unit.

3. The information processing apparatus according to claim 1,
wherein the power switch is operable when a long press of the predetermined time or longer has been made, to generate a first power shut-off instruction that maintains a certain level for a time equal to the predetermined time and input the first power shut-off instruction into the control unit without inputting into the host apparatus, and
the control unit is operable when the first power shut-off instruction has been detected, to generate a second power shut-off instruction that maintains a certain level for a longer time than the predetermined time and shuts off the operation power of the host apparatus according to the second power shut-off instruction.

4. The information processing apparatus according to claim 1,
wherein when it has been detected that cutting off the operation power of devices included in the host apparatus or the peripheral device is not possible, the control unit gives notification of a power shut-off error based on standby power.

5. The information processing apparatus according to claim 1,
wherein the control unit switches an internal state to an operation power shut-off complete state when shutting off of the operation power of the host apparatus and the peripheral device has been completed, and
when the internal state is not the operation power shut-off complete state, the control unit shuts off the operation power of the host apparatus and the peripheral device when a long press of a predetermined time or longer of the power switch has been detected.

6. The information processing apparatus according to claim 1,
wherein the peripheral device includes:
a relay device that has an expansion bus and relays communication via the expansion bus;
a computational processing device group including a plurality of computational processing devices that are individually connected to the expansion bus; and
a power supply unit that is a power supply for the operation power, and
the control unit shuts off the operation power to the computational processing device group, the relay device, the host apparatus, and the power supply unit in that order when it has been detected that all of the computational processing devices in the computational processing device group are in a non-operating state.

7. The information processing apparatus according to claim 1,
wherein the peripheral device includes:
a relay device that has an expansion bus and relays communication via the expansion bus;
a computational processing device group including a plurality of computational processing devices that are individually connected to the expansion bus; and
a power supply unit that is a power supply for the operation power, and
the control unit shuts off the operation power of the host apparatus without shutting off the operation power of the computational processing device group, the relay device, and the power supply unit when at least one computational processing device out of the computational processing device group is in an operating state when a long press of a predetermined time or longer of the power switch is made.

8. An information processing system comprising,
a host apparatus; and
an information processing apparatus including:
a peripheral device connected to the host apparatus; and
a control unit that executes control over supplying of operation power to the host apparatus and the peripheral device, monitors an operation state of a power switch, and is operable when a long press of a predetermined time or longer of the power switch has been detected, to shut off the operation power being supplied to the host apparatus and the peripheral device in a predetermined order.

9. A non-transitory computer-readable recording medium storing therein a computer program that causes a computer to execute a process comprising:
executing control over supplying of operation power to a host apparatus and a peripheral device connected to the host apparatus; and
monitoring an operation state of a power switch, and shutting off, when a long press of a predetermined time or longer of the power switch has been detected, the operation power being supplied to the host apparatus and the peripheral device in a predetermined order.
